(19) United States
(12) Patent Application Publication
(10) Pub. No.: US 2005/0225099 A1
(43) Pub. Date: Oct. 13, 2005

(54) Door security brace

(76) Inventor: Craig D. Quarberg, Monticello, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 10/823,137

(22) Filed: Apr. 13, 2004

(51) Int. Cl. E05C 3/06

(52) U.S. Cl. 292/339

(57) ABSTRACT

A security brace for impeding forced entry into a room through an entry door. The brace comprises a plurality of elongated pole members with foot members secured at a first end of the pole member, and a block member operatively coupled to a second end of the pole members. The block member has a top planar surface with a yoke projecting upward from the top planar surface. The yoke is adapted to receive the shaft of a door knob lock set. When an uninvited intruder applies force to open the entry door, the force vector is directed down the pole members and holds the foot members against the floor, thus impeding the door from swinging open.

### BACKGROUND OF THE INVENTION

I. Field of the Invention

This invention relates generally to building security devices, and more particularly to a portable bar arrangement designed to prevent a door from being forced open.

II. Discussion of the Prior Art

Security in one's home is a paramount value in today's society. As reflected in films such as “Panic Room”, Americans desire to know that they are going to be safe from a violent or criminal invasion of their home. In particular, individuals wish to know that a burglar will not be able to kick in a building's entry door.

Most people rely on conventional locksets to keep invaders out of their home. These locksets typically have a key-operated bolt which is too short relative to its depth of penetration into an adjacent door jam to resist the force of an adult kicking in the door or lunging at the door with his shoulder. With little force, a burglar can crack and shatter a wooden door jams.

In addition to conventional locksets homeowners may deploy a variety of other devices including slide bolts, chains, and other devices which can be overcome using a pry bar or a bolt cutter.

Applicant's U.S. Pat. No. 5,064,232 entitled “Entry Door Security Bar” represented a step forward in overcoming the deficiencies of previous locking mechanisms. The device claimed by the '232 patent comprised a single pole having a footpad at its lower end and a specially designed head member at the upper end of the pole. The head member had a semi-circular grove for receiving a door knob. When the head member received the door knob, and the foot member intersected with the floor, the force vector resulting from someone pushing against the entry door was directed downward which prevented the door from opening. However, as intruders have become stronger, the stress on the bar has become greater. Intruders using a battering ram or other such tools maybe able to overcome the resistance provided by the '232 brace.

### SUMMARY OF THE INVENTION

The present invention is a novel and substantial improvement over Applicant's '232 patent. The present invention comprises plurality of pole members for supporting a block member that is adapted to engage a door knob. The plurality of pole members preferably includes at least three such pole members, with a central pole member and two side pole members that are set at a predetermined angle to the vertical. Each pole member has an upper end and a lower end. Each pole member further includes a foot member secured to the lower end. Each foot member includes a non-skid floor engaging surface. The non-skid surface may be an elastomeric pad, that includes a plurality of laterally extending corrugations. The pole members each comprise first and second, tubular, telescoping segments, and a means for locking said segments relative to one another at a predetermined composite length. The telescoping segments allow the brace to be collapsed for easy storage and transportation. The collapsible pole members also allow the brace to be adjusted to adapt to door knobs of various heights from a floor surface.

The block member has a top planar surface with an upwardly extending yoke. The base of the yoke extends perpendicularly from a midpoint of the top planar surface. A head member of the yoke slopes upward at a predetermined angle to the longitudinal axis of the yoke base. The head member has a generally semicircular recess which is adapted to receive the door knob. The block member further includes a bottom surface with a plurality of circular apertures dimensioned to receive the ends of respective pole members therein. When the pole members are at predetermined angles to the floor, and the yoke is engaged with the door knob, the force vector resulting from someone pushing against the door is dispersed and directed downward along the pole members. This dispersal better prevents the footpad from sliding along the floor.

### DESCRIPTION OF THE DRAWINGS

The foregoing objects, advantages, and features of the invention will become apparent to those skilled in their from the following detailed description of the preferred embodiment, especially when considered in conjunction with the accompanying drawings in which like numerals in the several views refer to the corresponding parts.

FIG. 1 is a front elevation view of the security brace comprising the preferred embodiment of the present invention;

FIG. 2 is a front elevation view of the block member of FIG. 1;

FIG. 3 is a bottom elevation view of the block member of FIG. 1;

FIG. 4 is a partial view of the footpad of FIG. 1; and

FIG. 5 is a view showing the manner in which the security brace of FIG. 1 is used to prevent forced entry through a room door.

### DESCRIPTION OF THE PREFERRED EMBODIMENT

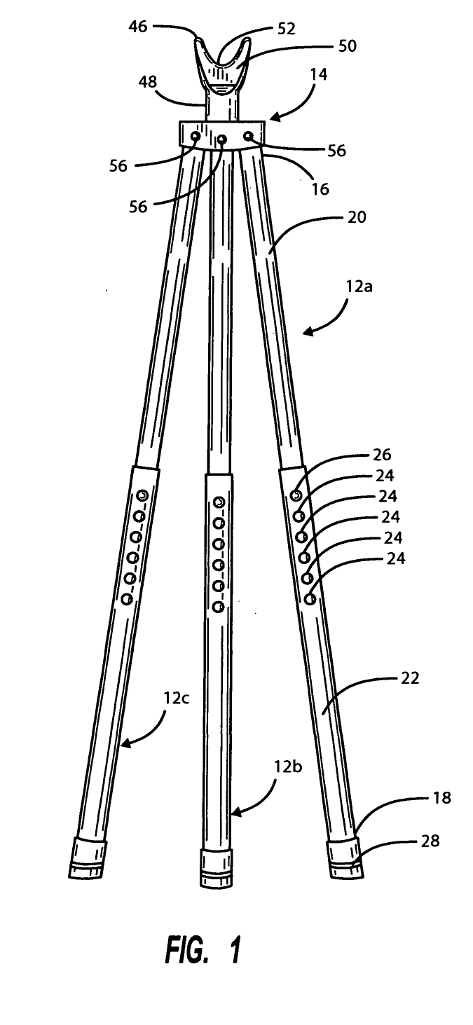

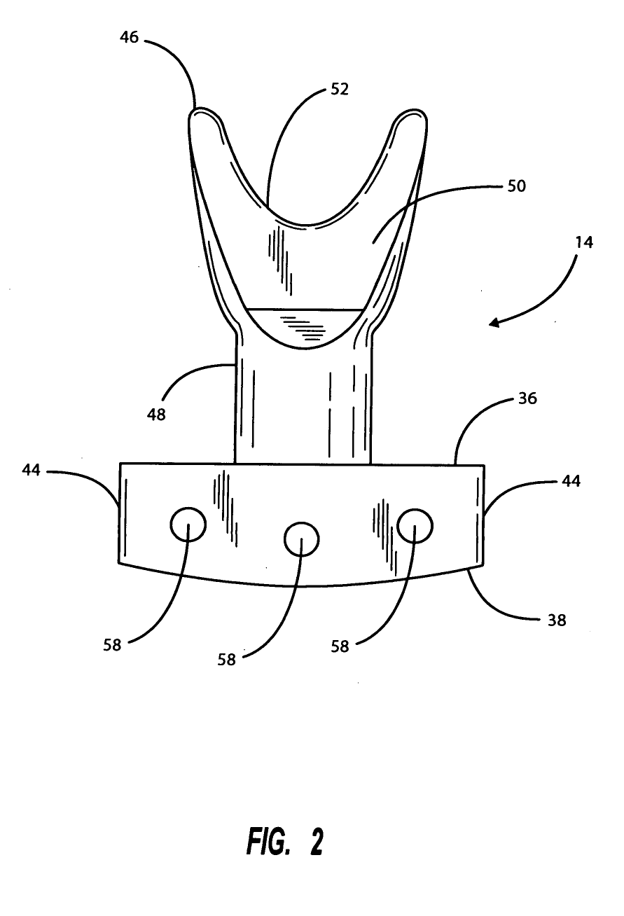

Referring first to FIG. 1, there is indicated generally by numeral 10 an entry door security brace for barring entry into a room through its door. The security brace 10 comprises a plurality of pole members 12a, 12b, 12c and a block member 14. Pole members 12a, 12b, 12c are each identical in composition. Each pole member has an upper end 16 and a lower end 18. The pole members may be solid, but preferably comprise an upper tubular segment 20 and lower tubular segment 22 of generally equal length where the internal diameter of the upper segment 20 and the external diameter of the lower segment 22 are such that the upper segment 20 can telescopically fit within the interior of the lower segment 22. In this way, the device can be collapsed into a more compact length for easy of transportation in a suitcase or the like. When in use, the unit will extend until a bottom detent 26 disposed on a lower portion of the upper segment 20 passes through the aligned aperture 24. This will prevent the pole member from collapsing under a heavy load.

Affixed to the lower end 18 of each pole member 12a, 12b, 12c, is a footpad 28. The footpad 28 comprises an upwardly extending circular socket 30 and a molded plastic base 32 with corrugations 34. The footpad 28 is affixed to the lower end 18 by inserting the lower end 18 into the socket 30. The corrugations 34 engage the floor or carpet fibers to prevent the footpad 28 from slipping or marring a floor surface. The footpad 28 is preferably made of an elastomeric material. The socket 30 is angled with respect to the molded plastic base 32 as such the pole member can be positioned at an angle to the floor while the molded plastic base 32 rests flat on the floor.

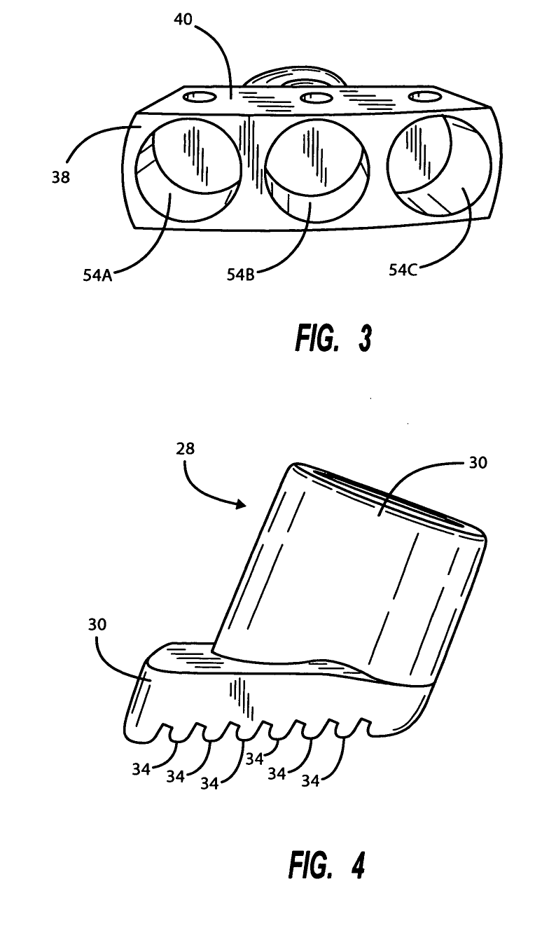

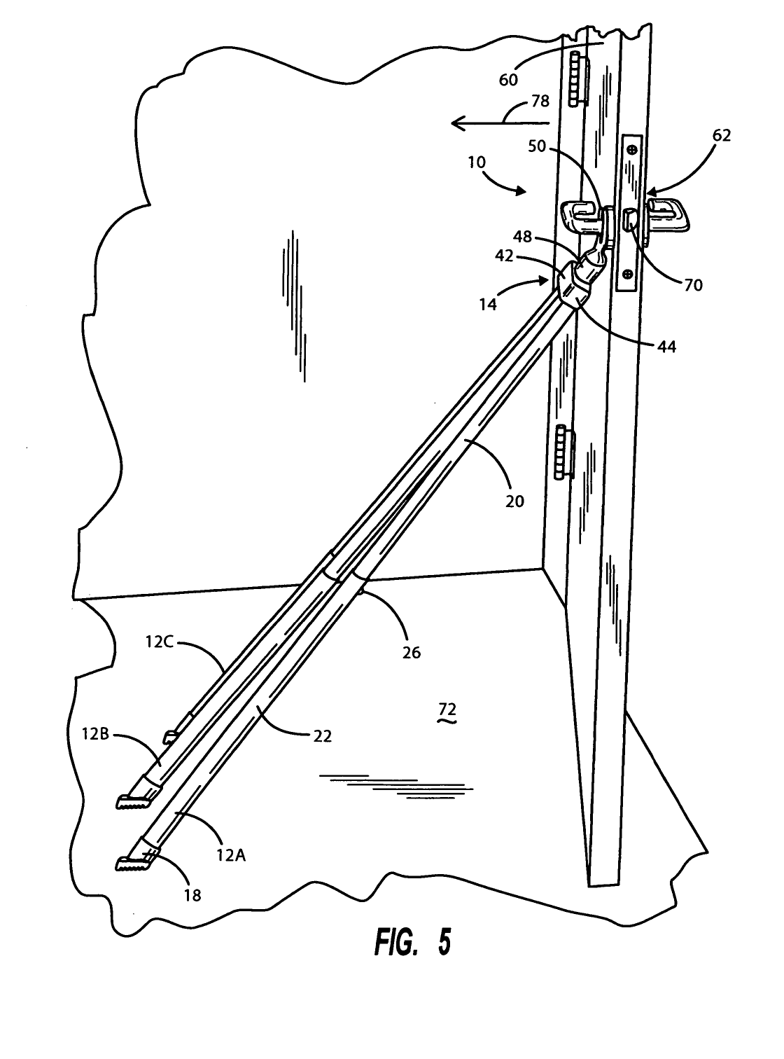

The block member 14 has a top planar surface 36, a bottom surface 38, a front and rear surface 40, 42, and a pair of side surfaces 44. An upwardly extending yoke 46 extends at the midpoint of the top planar surface 36. The yoke comprises a rounded yoke base 48 and a head member 50. The yoke base 48 is perpendicular to the top planar surface 36. The head member 50 slopes at a predetermined angle to the longitudinal axis of the yoke base 48. As seen in FIGS. 1 and 3, the head member 50 has a semi circular recess 52 formed through the head member 50.

The bottom surface 38 of the block member 14 includes a plurality of non-intersecting circular apertures 54a, 54b, 54c. An end portion 16 of pole member 12a is inserted into circular aperture 54a. Likewise, pole member 12b is inserted into circular aperture 54b and pole member 12c is inserted into circular aperture 54c. The front surface 40 of the block member 14 has a plurality of front surface apertures 58. Each pole member further includes an upper ball detent 56 disposed proximate its upper end 20. The upper ball detent 56 passes through the front surface aperture 58.

The yoke 46 is preferably covered with a non-abrasive material, such as an elastomeric pad to prevent scratching of when put in place and removed.

Referring next to FIG. 5, the manner in which the security brace 10 of the present invention is used will be explained. In FIG. 5, there is shown a portion of an entry door 60 in which a lockset is installed. The lockset is indicated generally by numeral 62. The lockset 62 includes a pair of knobs on opposite side surfaces of the door 60. The knobs are operatively coupled to a shaft (not shown) which cooperates with the bolt 70. By turning the knob, the bolt 70 can be retracted free of a socket formed in the adjacent door jam. The floor of the building is identified by the numeral 72.

The security brace 10 is installed by first extending the telescoping segments 20 and 22 of each of the pole members 12a, 12b, and 12c, and locking them together by the bottom detent 26, all as previously described. The block member 14 is operatively coupled to the upper ends 16 of the pole members 12a, 12b, and 12c by the top ball detent 56 as previously described. The semicircular recess 52 formed in the head member 50 is sized to capture the shaft of the lockset 62 to which a door know is secured. When the semicircular recess 52 captures the shaft, the head member 50 rests flat against the side surface 74 of the entry door 60.

When force is applied to the entry door 60 in the direction shown by arrow 76, the vector of force is directed down the pole members 12a, 12b, and 12c, to hold footpads 28 against the floor 72. The downward force vector prevents movement of the brace 10 on the floor 72. This prevents the entry door from swinging open.

This invention has been described herein in considerable detail in order to comply with the Patent Statutes and to provide those skilled in the art with the information needed to apply the novel principles and to construct and used such specialized components as are required. However, it is understood that the invention can be carried out by specifically different equipment and devices, and that various modifications, both as to the equipment details and operating procedures, can be accomplished without departing from the scope of the invention itself.

1. An entry door security brace for impeding forced entry into a room through a door, said door having a lockset with a pair of knobs on opposite side surfaces of the doors, the knobs being operatively coupled to a shaft, said brace comprising:
a) a plurality of pole members wherein said pole members include and upper end, and lower end with a foot member secured to the lower end of said pole member; and
b) a block member secured to the upper ends of said plurality of pole members, said block member having a top planar surface with a yoke extending upward from the top planar surface, said yoke adapted to receive said shaft.

2. The security brace in claim 1 where the plurality of pole members each comprise first and second tubular telescoping segments and means for locking said segments relative to one anther at a predetermined composite length.

3. The security brace in claim 1 wherein the pole members are secured to the block member by a plurality of circular apertures in a bottom surface of the block, wherein the pole members pass through the apertures and said pole members are held in the block member by a locking member.

4. The security brace in claim 1 wherein said foot member includes a non-skid floor engaging surface.

5. The security brace in claim 4 wherein said non-skid surface is an elastomeric pad.

6. The security brace in claim 4 wherein said non-skid surface includes a plurality of downwardly projecting corrugations.

7. The security brace in claim 1 wherein the yoke is attached to a block member by a cylindrical stem extending upwardly from the top surface for fitting into a circular opening in the bottom of the yoke.
